(19) United States
(12) Patent Application Publication
(10) Pub. No.: US 2020/0041790 A1
(43) Pub. Date: Feb. 6, 2020

(54) CATADIOPTRIC FREEFORM HEAD MOUNTED DISPLAY

(71) Applicant: Google LLC, Mountain View, CA (US)

(72) Inventors: Oscar MARTINEZ, Mountain View, CA (US); Yi QIN, Mountain View, CA (US); Xinda HU, Mountain View, CA (US)

(21) Appl. No.: 16/053,297

(22) Filed: Aug. 2, 2018

(51) Int. Cl. G02B 27/01; G02B 1/11; G02B 5/30; G02B 17/08

(52) U.S. Cl. CPC G02B 27/0172; G02B 1/11; G02B 2027/013; G02B 17/0804; G02B 2027/0178; G02B 5/3041

(57) ABSTRACT

An optical device, such as a head mounted display, includes a display that emits light, a reflector, and a partially reflective circular polarizer (RCP) positioned between the reflector and a user's eye or eyes. The reflector can be partially reflective. The partially reflective circular polarizer, the reflector, or both, can be curved. Light from the display is reflected one or more times by the reflector. The RCP can include one or more of a quarter-wave plate (QWP), a reflective polarizer layer, a linear polarizer, a supportive substrate, and an anti-reflective film. The reflector can include a mirror coating and an anti-reflection coating.

### BACKGROUND

One approach for fabricating a head mounted display (HMD) is to use a curved mirror in combination with a partially reflective material. This combination yields a short focal length and a wide field of view for a wearer of the HMD. A partially transparent HMD allows the wearer to contemporaneously view a displayed image and the scene in front of the wearer. In different modes of operation, the see-through HMD presents the displayed image so that the area of the displayed image is transparent, semi-transparent, or opaque. In the transparent mode, the see-through view of the scene is unblocked, and an overlaid displayed image can be provided with low contrast. In the semitransparent mode, the see-through view of the scene is partially blocked, and an overlaid displayed image can be provided with higher contrast. In the opaque mode, the see-through view of the scene is fully blocked, and an overlaid displayed image can be provided with high contrast.

Some implementations of an HMD provide a see-through display for an augmented reality view in which real-world scenes are visible to a user and additional image information is overlaid thereon. Such an augmented reality view is provided by helmet mounted see-through displays found in military applications and by heads-up displays (HUDs) in windshields of automobiles. In such embodiments, there can be multiple areas for displaying images over the see-through view.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a simplified diagram of a side view of a catadioptric head mounted display (HMD) in accordance with various embodiments.

FIG. 2 is an overhead cross-sectional view along line 1-1 of the catadioptric HMD shown in FIG. 1.

FIGS. 3-7 are diagrams of side views of arrangements of elements of catadioptric HMDs in accordance with various embodiments.

FIG. 8 is a diagram of a top view of a catadioptric HMD in accordance with some embodiments.

FIG. 9 is an exploded diagram of elements of portions of a catadioptric device in accordance with various embodiments.

FIG. 10 is a flowchart illustrating a method of providing light to a user by way of a catadioptric device in accordance with various embodiments.

### DETAILED DESCRIPTION

Catadioptric systems employ both refraction and reflection to provide certain benefits including building a lighter head mounted display (HMD). Catadioptric HMDs provide a wide field of view (FOV) for a wearer. Described herein are embodiments of catadioptric HMDs that combine at least one small electronic display with two optical elements: a polarizing filter and a combiner. The combiner is also known as a reflector. Some embodiments use a freeform partially reflective shell as the reflector, and a reflective circular polarizer as the polarizing filter. The reflector is curved along one or more axes of orientation with respect to an eye of a wearer. A curved reflector shapes or directs a resulting image to an eye pupil. According to certain embodiments, the image is formed from visible light energy. One or more of the elements are freeform where freeform as used herein means at least that a curvature in a surface is without a rotational symmetry or is rotationally asymmetric. For example, a surface of the polarizer or a surface of the reflector does not have a rotational symmetry along one directional axis or along two directional axes. According to some embodiments, the components do not share a same optical axis. For example, a first optical axis of the polarizing filter is offset or not aligned with a second optical axis of the freeform partially reflective shell.

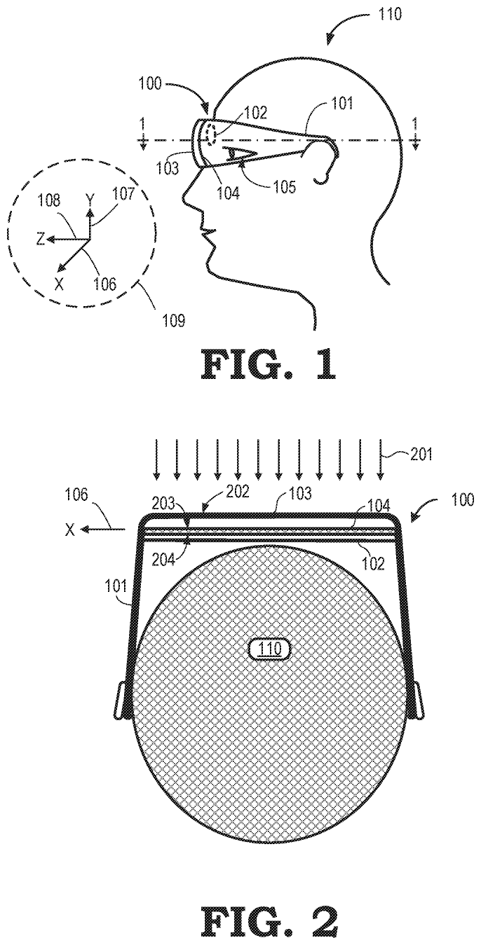

The reflective circular polarizer eliminates a use of or a need for total internal reflection (TIR). Circular polarization as described herein means at least an electromagnetic wave having a polarization in which, at each point, an electric field of the wave has a constant magnitude and its direction rotates with time in a plane perpendicular to the direction of the wave. This arrangement allows the optical components to be thin shells (e.g., <1.0 mm, <1.5 mm, and <2.0 mm), and does not require a compensating prism for augmented reality (AR) as required in a conventional freeform prism architecture when a see-through outer shell is used to allow ambient light to enter the device. Further, only a single polarizing filter is needed to manage the polarization states throughout the light path. The combination of the elements facilitates virtual reality (VR) and AR vision for the wearer. FIGS. 1-10 illustrate aspects of the optical architecture further described herein.

Avoiding the use of thick freeform prisms reduces weight, improves aesthetics, and eliminates chromatic aberrations. A result is sleeker and lighter optics for an improved form-factor which is more likely to be adopted by consumers. Some embodiments include use of just two thin shells as opposed to thick prisms of conventional designs. It is possible to use either a single or double reflection from the combiner which can be a freeform combiner.

FIG. 1 is a simplified diagram of a side view of a catadioptric HMD in accordance with various embodiments. Each of the elements of the HMD 100 takes the form of one of various possible embodiments as further described herein. The HMD 100 includes a frame 101 that supports at least one electronic display 102 that produces unpolarized light for one or both user eyes 105 of a user 110. The frame 101 includes one or more arms that extend from a front of the user 110 and rest on one or more ears on a side of the user's head. According to at least some embodiments, a portion of the frame 101 rests on a bridge of a nose of the user 110. A combiner or reflector 103 is positioned outside of a polarization filter 104. The polarization filter 104 is in a light path between the electronic display 102 and an expected position of one or both user eyes 105. As shown, the polarization filter 104 is on an eye-ward side of the reflector 103 and on a world-facing side of the display 102. The reflector 103 reflects at least a portion of light from the electronic display to one or both user eyes 105.

A vision and device coordinate system 109 provides a reference for FIG. 1 and the other figures described herein. According to some embodiments, each of the reflector 103 and the polarization filter 104 are curved along at least one of a first axis or dimension 106 labeled X and along a second axis 107 labeled Y, the second axis 107 different than the first directional axis 106. A curvature along the first axis 106 may be referred to as a horizontal arc along a certain number of degrees of azimuth with respect to the HMD 100 and the user 110. A curvature along the second axis 107 may be referred to as a vertical arc along a certain number of degrees of altitude with respect to the HMD 100 and the user 110. A third axis 108 is labeled Z and is an optical axis relative to the user's eyes 105 and for the optical elements of the HMD 100.

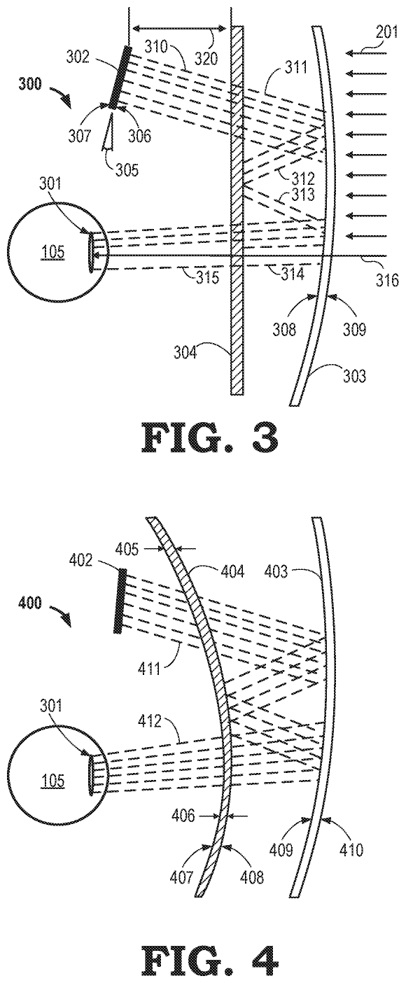

FIG. 2 is an overhead cross-sectional view along line 1-1 of the catadioptric HMD 100 shown in FIG. 1. Ambient light 201 passes through a front surface 202 of the reflector 103 and through the polarization filter 104 to reach the eyes of the user 110. The frame 101 supports the electronic display 102, the reflector 103, and the polarization filter 104. The polarization filter 104 includes a front surface 203 and a back surface 204. According to the embodiment shown, each of the reflector 103 and the polarization filter 104 is substantially planar along a first axis 106.

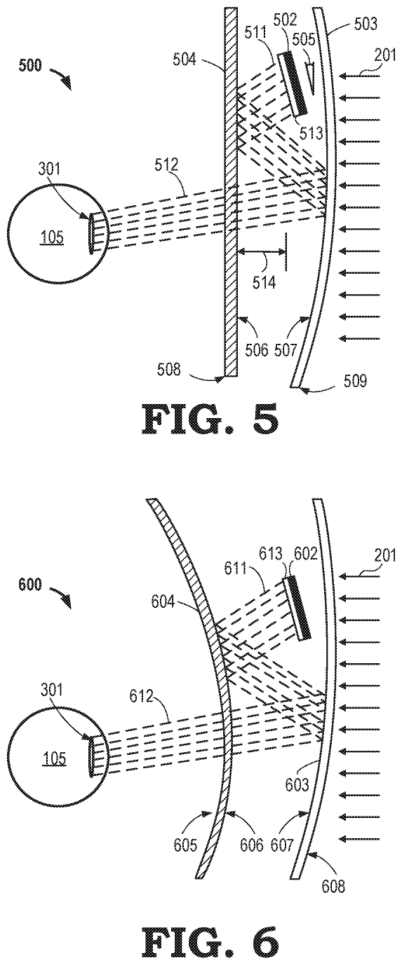

FIG. 3 is a diagram of a side view of an arrangement 300 of elements of a catadioptric HMD in accordance with various embodiments. Support elements are omitted for clarity of illustration and are present in assembled HMDs as understood by those in the art. A pupil 301 of a user eye 105 is behind a partially reflective reflector 303 and a partially reflective polarization filter 304.

The reflector 303 includes a first interior or eye-facing surface 308 and an exterior or world-facing surface 309. While the reflector 303 is shown as a single material, the reflector 303 comprises one or more layers of one or more various materials. For example, the reflector 303 takes the form of a freeform thin shell that includes a partial mirror coating on a substrate such as on the eye-facing surface 308 and an anti-reflecting coating on the substrate on the world-facing surface 309. The polarization filter 304 also is shown as a single material. However, the polarization filter 304 comprises one or more layers of one or more various materials according to various embodiments. For example, the filter 304 includes a planar substrate, a linear polarizer, a linearly polarizing reflective film, and a quarter-wave retarder film.

The eye 105 receives light emitted from an electronic display 302 after it has traveled along a light path within the HMD. The filter 304 generates circular polarized light from the display 302. The filter 304 reflects orthogonal circular polarized light after the light reflects a first time from the reflector 303. The filter 304 transmits circular polarized light after the light reflects a second time from the reflector 303.

According to some embodiments, the eye 105 also receives light from an ambient outside of the catadioptric HMD. According to some embodiments, the display 302 is oriented at an angle 305 relative to an axis of the substantially planar partially reflective polarization filter 304. In other embodiments, the display 302 is placed parallel or contiguous with a proximate surface of the partially reflective polarization filter 304. Preferably, light 310 emanates from a front or first side or surface 306 of the electronic display 302 and not from a back or second side 307 of the electronic display 302.

The display 302 is shown as substantially planar at least along a first surface 306. The display 302 includes a second or back surface 307. The display 302 is either substantially planar, or contoured or curved, depending on the particular embodiment. The display 302 is shown and assembled in the HMD a distance 320 from an interior surface of the polarization filter 304. However, the display 302 may be mounted to or formed directly contiguous with the polarization filter 304. An actual construction of the display 302 uses organic light emitting diodes (OLED), light emitting diodes (LED), or any other suitable material or combination of elements to produce a plurality of light emitting sources which are arranged on a substantially locally continuous surface such as an edge-illuminated element and a liquid crystal display (LCD). According to some embodiments, the display 302 provides a rectangular array of light emitting elements. According to some embodiments, the display 302 is transparent or semi-transparent and that transparency can be either an overall general passing of light or take a form of a dot type beam splitter where there are small non-transparent elements on a largely transparent substrate so that the overall effect is that the display allows light to pass through it.

In some embodiments, a surface of the display 302 is shaped to fit a contour of at least a portion of the interior surface of the partially reflective polarization filter 304. According to certain embodiments, the angle 305 of the orientation of the display 302 is coordinated with a contour or curvature of the reflector 303 so as to shape a size and orientation of an image reaching the pupil 301 when reflected from one or more surfaces of the reflector 303 and from one or more surfaces of the polarization filter 304. Any curvature in the display 302, along one or two axes of orientation is coordinated with curvature in one or more axes of curvature of the reflector 303 and coordinated with curvature in one or more surfaces of the polarization filter 304. The polarization filter 304 is shown substantially planar in FIG. 3. According to various embodiments, the curvature in one or more of the reflector 303 and the polarization filter 304 is any suitable curved element that has a spherical or aspherical or compound shape and a uniform or non-uniform thickness as needed to shape the image of light reaching the pupil 301 of the eye 105 from the display 302.

A portion 316 of the ambient light 201 passes through the partially reflective reflector 303 and the partially reflective polarization filter 304 to reach the user eye 105. Light 310 emanating from the display 302 is unpolarized. According to some embodiments, light 311 that first passes through the partially reflective polarization filter 304 is left-handed circular-polarized light 311. Upon reflection from the partially reflective reflector 303, the light become right-handed circular polarized light 312. Light 313 that has been reflected a first time from the partially reflective polarization filter 304 remains right-handed circular-polarized. Upon a second reflection from the partially reflective reflector 303, light 314 again becomes left-handed circular polarized light 314 and is converted to linearly polarized light 315 after passing through the partially reflective polarization filter 304. At each element 303, 304, a portion of the light 310 is either reflected or transmitted. Consequently, not all light leaving the electronic display 302 reaches the eye 105 of the user.

FIG. 4 is a diagram of a side view of an arrangement 400 of elements of a catadioptric HMD in accordance with additional embodiments. A pupil 301 of a user eye 105 is behind a curved partially reflective reflector 403 and a curved partially reflective polarization filter 404. The reflective polarization filter 404 includes a first inner surface 407 that is concave in contour along at least one directional axis and a second outer surface 408 that is convex. The filter 404 is of a first thickness 405 at a first position and of a second thickness 406 at a second position. According to some embodiments, the filter 404 is a uniform thickness along the body of the filter 404 at least at positions along the light path of light provided by a display 402. The light path extends between the display 402 and the user eye 105. According to some embodiments, light 411 leaves the display 402 in a non-polarized state and, after passing through the filter 404, becomes polarized light 412. Only a fraction of the light 411 leaving the display 402 arrives at the pupil 301 of the user eye 105 due to the elements of the HMD.

The reflector 403 includes a first interior concave surface 409 and an exterior convex surface 410. According to some embodiments, the eye 105 also receives ambient light from an ambient outside of the catadioptric HMD but is not shown for sake of simplicity in illustration. In the arrangement 400 shown, light from the display 402 is reflected at least two times from the partially reflective reflector 403 and at least one time from the filter 404 before reaching the user eye 105. An outer surface 408 of the filter 404 is positioned relative to the inner surface 409 of the reflector 403 in the assembled HMD to provide light from the display 402 to the user eye 105. An orientation, a position, or both an orientation and a position of the display 402, relative to the other elements, are selected for the HMD. A shape, a position, or both a shape and an orientation of the filter 404, relative to the other elements, are selected for the HMD. Also, a shape, a position, or both a shape and an orientation of the reflector 403, relative to the other elements, are selected for the HMD. These features are arranged together to shape a resulting image generated by the light originating from the display 402 to the user eye 105.

While the reflector 403 is shown as a single material in FIG. 4, the reflector 403 comprises one or more layers of one or more various materials. For example, the combiner or reflector 403 takes the form of a freeform thin shell that includes a partial mirror coating on a substrate such as on the eye-facing surface 409 of the substrate and an anti-reflection coating on the world-facing surface 410 of the substrate. Freeform for the reflector 403 refers to a curvature or contour along a first axis or orientation, a curvature or contour along a second axis or orientation, or along both the first and the second axes.

The polarization filter 404 also is shown as a single material in FIG. 4. However, the polarization filter 404 comprises one or more layers of one or more various materials according to various embodiments. For example, the filter 404 includes a curved or contoured base substrate such as a plastic or glass layer, a linear polarizer, a linearly polarizing reflective film, and a quarter-wave retarder film. The filter 404 generates circular polarized light from the display 402. The filter 404 reflects orthogonal circular polarized light after a first reflection from the reflector 403 and transmits circular polarized light after a second reflection from the reflector 403. The filter 404 is shown curved along a first directional axis. The filter 404 may be curved along a second directional axis to conform with the shape of a user's head. The filter 404 is a freeform surface. Freeform for the filter 404 as used herein includes a curved or contoured surface without a rotational symmetry along at least one or first axis or orientation of the filter 404 surface. The curvature also may be along a second axis or orientation of the filter 404.

FIG. 5 is a diagram of a side view of another arrangement 500 of elements of a catadioptric HMD in accordance with various embodiments. Support elements are omitted for clarity of illustration and are present in assembled HMDs as understood by those in the art. In this arrangement 500, an electronic display 502 is positioned on an eye-side of a partially reflective reflector 503 and a world-facing side of a substantially planar partially reflective polarization filter 504. A pupil 301 of a user eye 105 receives light emitted from the display 502 after light has traveled along a light path associated with the HMD. The arrangement 500 includes a first circular polarization filter 513 positioned in the light path before light from the display 502 reaches the substantially planar partially reflective polarization filter 504. The eye 105 also receives at least a portion of the ambient light 201 that passes through the partially reflective reflector 503 and the filter 504 in AR embodiments. While illustrated with substantially co-extensive reflector 503 and filter 504, according to some embodiments, a distal end 509 of the partially reflective reflector 503 is shorter than and does not extend to a similar extent as a distal end of the partially reflective polarization filter 504. A shorter reflector 503 may be implemented to reduce a vertical aperture size of the reflector 503, so that an outer shell of the HMD ends before reaching the display 502.

According to some embodiments, light generated by the display 502 leaves the display 502 in a non-polarized state and passes through the first filter 513. While the first filter 513 is shown as a single element or material in FIG. 5, the first filter 513 comprises one or more layers of one or more various materials. For example, the first filter 513 includes a linear polarizer and a quarter-wave retarder film. Light from the display 502 that has passed through the first filter 513 is circular polarized light 511. While the first filter 513 is shown proximate or contiguous to the display 502 in FIG. 5, in other embodiments, the first filter 513 is spaced away or air-gapped from the display 502. In yet other embodiments, the first filter 513 is positioned proximate to or contiguous at least in part with a proximate outer (world-facing) surface 506 of the partially reflective polarization filter 504 and sized appropriately to allow for light from the display 502 to pass through the first filter 513 just one time along the optical path from the display 502 to the user eye 105.

The planar filter 504 reflects at least a portion of the light emitted from the display 502 toward the reflector 503. Farther along the optical path, the planar filter 504 transmits linear polarized light 512 to the pupil 301 of the user eye 105.

According to some embodiments, the display 502 is oriented at an angle 505 relative to an axis of the substantially planar partially reflective polarization filter 504. In other embodiments, the display 502 is placed parallel or contiguous with a proximate surface of the partially reflective polarization filter 504. Preferably, light emanates from a front or first side of the electronic display 502 and not from a back or second side of the electronic display 502. The display 502 is shown as substantially planar. The display 502 is either substantially planar, or contoured or curved, depending on the particular embodiment. The display 502 is shown and assembled in the HMD a distance 514 from an interior surface of the filter 504. However, the display 502 may be mounted to or formed directly contiguous with the planar filter 504 such as at or proximate to a first surface 506. As an example, a first point or first edge of the display 502 is mounted proximate or contiguous to either the reflector 503 or filter 504. A surface of the display 502 is shaped to match or mate with a planar surface or contoured surface of at least a portion of the first surface 506 of the filter 504 or a first or interior surface 507 of the reflector 503. The display 502 remains non-parallel in these embodiments.

According to certain embodiments, the angle 505 of the orientation of the display 502 is coordinated with a contour or curvature of the reflector 503 so as to shape a size and orientation of an image reaching the pupil 301 when reflected from one or more surfaces of the reflector 503 and from one or more surfaces of the planar filter 504. Any curvature in the display 502, along one or two axes is coordinated with curvature in one or more axes of curvature of the reflector 503 and coordinated with a position of the planar filter 504 relative to the other elements. The planar filter 504 is shown substantially planar in FIG. 5 as an illustrated embodiment. According to certain embodiments, light that passes through the partially reflective polarization filter 504 is linear polarized light 512. At each element 503, 504, a portion of the light 511 is either reflected or transmitted. Consequently, not all light leaving the electronic display 502 reaches the user eye 105.

FIG. 6 is a diagram of a side view of an arrangement 600 of elements of a catadioptric HMD in accordance with additional embodiments. A pupil 301 of a user eye 105 is behind a curved partially reflective reflector 603 and a curved partially reflective polarization filter 604. The display 602 is positioned between the reflector 603 and the filter 604. In the embodiment shown, the display is oriented to emit light first toward the filter 604. The filter 604 includes a first inner surface 605 that is concave in contour along at least one directional axis and a second outer surface 606 that is convex. Light emitted from the display 602 travels along a light path to the pupil 301 of the user eye 105.

According to some embodiments, light leaves the display 602 in a non-polarized state and passes through a first circular polarizing filter 613 to produce circular polarized light 611. While the first filter 613 is shown as a single element or material in FIG. 6, the first filter 613 comprises one or more layers of one or more various materials. For example, the first filter 613 includes a linear polarizer and a quarter-wave retarder film. Further, while the first filter 613 is shown proximate or contiguous to the display 602 in FIG. 6, in other embodiments, the first filter 613 is spaced away or air-gapped from the display 602. In yet other embodiments, the first filter 613 is positioned proximate to or contiguous at least in part with the second outer surface 606 of the curved partially reflective polarization filter 604 and sized appropriately to allow for light from the display 602 to pass through the first filter 613 just one time.

After passing through the first filter 613, and reflecting from the reflector 603, the light passes through the curved partially reflective polarization filter 604 and becomes linear polarized light 612 before reaching the user eye 105. Only a fraction of the light leaving the display 602 arrives at the pupil 301 of the user eye 105 due to the partially reflective, partially transmissive elements 603, 604 of the HMD.

According to some embodiments, the eye 105 also receives ambient light 201 from an ambient outside of the catadioptric HMD. The light from the display 602 augments the light from the ambient that reaches the user eye 105. In the arrangement 600 shown, light from the display 602 is reflected at least one time from the partially reflective reflector 603 and at least one time from the filter 604 before reaching the user eye 105. The convex outer surface 606 of the filter 604 is positioned relative to an inner surface 607 of the reflector 603 in the assembled HMD to provide light from the display 602 to the user eye 105. An orientation, a position, or both an orientation and a position of the display 602, relative to the other elements, are selected for the HMD. A shape, a position, or both a shape and an orientation of the filter 604, relative to the other elements, are selected for the HMD. Also, a shape, a position, or both a shape and an orientation of the reflector 603, relative to the other elements, are selected for the HMD. These features are arranged together to shape a resulting image reaching the pupil 301 of the user eye 105 from the light originating from the display 602.

While the reflector 603 is shown as a single material in FIG. 6, the reflector 603 comprises one or more layers of one or more various materials. For example, the combiner or reflector 603 takes the form of a freeform thin shell that includes a mirror coating or a partial mirror coating on a substrate such as on the eye-facing surface 607 of the substrate and an anti-reflecting coating on the world-facing surface 608 of the substrate. Freeform for the reflector 603 refers to a curvature or contour along a first axis or orientation, a curvature or contour along a second axis or orientation, or along both the first and the second axes.

The polarization filter 604 also is shown as a single material in FIG. 6. However, the polarization filter 604 comprises one or more layers of one or more various materials according to various embodiments. For example, the filter 604 includes a curved or contoured base substrate such as a plastic or glass layer, a linear polarizer, a linearly polarizing reflective film, and a quarter-wave retarder film. The first filter 613 and the second filter 604 generate circular polarized light from the display 602. The second filter 604 reflects orthogonal circular polarized light without a reflection from the reflector 603 and transmits circular polarized light after a reflection from the reflector 603 as the light travels the light path from the display 602 to the user eye 105. The second filter 604 is shown curved along a first directional axis. The second filter 604 may be curved along a second directional axis to conform with the shape of a user's head (not shown). The second filter 604 is a freeform surface. Freeform for the second filter 604 refers to a curvature or contour along a first axis or orientation, a curvature or contour along a second axis or orientation, or along both the first and the second axes of the filter 604 surface.

FIG. 7 is a diagram of a side view of an arrangement 700 of elements of a catadioptric HMD in accordance with additional embodiments. A pupil 301 of a user eye 105 is behind a curved partially reflective reflector 703 and a planar partially reflective polarization filter 704. The display 702 is positioned proximate to portion of the filter 704. In some embodiments, the display 702 is fabricated with and coupled to the filter 704. In the embodiment shown, the display 702 is oriented to emit light first through the filter 704. The display 702 is rectangular in shape and has a first dimension 706 and a second dimension 707 which is orthogonal to the first dimension 706. For example, the first dimension 706 is approximately 22 mm and the second dimension 707 is approximately 36 mm. The polarizing filter 704 is a planar or flat substrate for the display 702. A resulting field of view for an image generated for a pupil 301 of the user eye 105 is approximately 45 degrees as measured diagonally. A cleanup linear polarizer 705 is coupled to the reflector 703. The reflector is a combiner of an image generated by the display 702 and incoming ambient light 201.

An inset 710 illustrates layers of the planar polarizing filter 704. According to some embodiments, the polarizing filter includes a supportive substrate 711, a quarter-wave plate (QWP) 712, a reflective polarizer 713, a linear polarizer (LP) 714, and an anti-reflective film 715. The supportive substrate 711 is made of a glass, a plastic, or other material. While the inset only shows a portion of the planar filter 704, it is understood that the layers 711-715 extend along an entire length and width of the filter 704. According to some embodiments, while not illustrated, the planar polarizing filter 704 includes an anti-reflection film or coating on a world-facing side of the glass substrate 711.

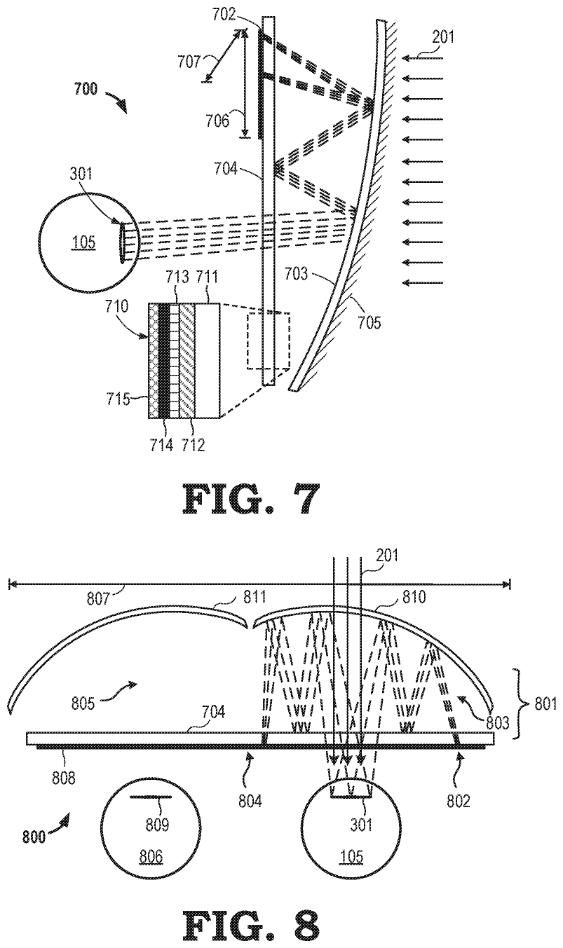

FIG. 8 is a diagram of an overhead view of an arrangement 800 of elements of a catadioptric HMD in accordance with certain embodiments including some of the elements previously described. The arrangement 800 includes one or more electronic displays such as display 808 extending planarly along a length or first dimension 807 of the planar partially reflective polarization filter 704. A first partially reflective reflector 810 and a second partially reflective reflector 811 are curved along the first dimension 807. The first reflector 810 is for the first user eye 105 and the second reflector 811 is for a second user eye 806. The reflectors 810, 811 and the filter 704 define a space 801 therebetween.

First light originating from a first position 802 of the display 808 travels along a first light path to the pupil 301 of the first eye 105. Second light originating from a second position 804 of the display 808 travels along a second light path 805 to the first eye 105. A second pupil 809 and the second eye 806 receive other light (not illustrated) from the display 808 as understood by those in the art. Such other light may originate from one or more of the first and second positions 802, 804 or from other locations of the display 808 to reach the user eyes 105, 806. Depending on the spatial arrangement of elements, a same image or separate images are provided to the respective pupils 301, 809 and the respective eyes 105, 806. According to some embodiments, ambient light 201 is combined with light from the display 808 to provide an augmented vision to the user eyes 105, 806. The arrangement 800 uses reflection, refraction, or a combination of reflection and refraction to provide light from the display 808 to the user eyes 105, 806.

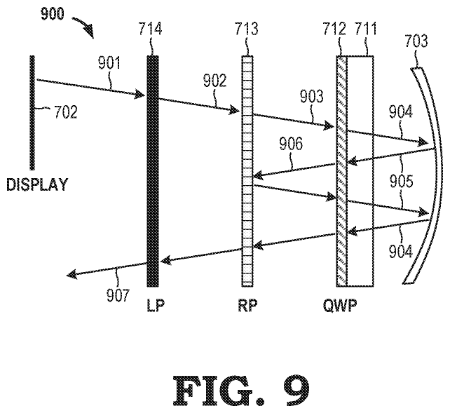

FIG. 9 is an exploded diagram of elements of portions of a catadioptric device in accordance with various embodiments. A display such as display 702 emits unpolarized light 901 toward a linear polarizer (LP) 714. Linearly polarized light 902 passes to and through a reflective polarizer (RP) 713. Linearly polarized light 903 from the RP 713 passes to and through a quarter-wave plate (QWP) 712 and a glass substrate 711 thereby becoming circularly polarized (CP) light 904. The CP light 904 is reflected from a curved partially reflective reflector 703 which changes its handedness. For example, for left-handed circularized light 904, the first reflected light 905 becomes right-handed circularized light. The first reflected light 905 passes through the glass substrate 711 and the QWP 712 and thereby becomes phase-shifted light 906. Such light is linear and orthogonal to the linear transmission polarization state such as that of a reflective polarizer such as polarizer 713 and with respect to a linear polarizer such as LP 714. The phase-shifted light 906 then is reflected by the RP 713 back through the QWP 712 and the glass substrate 711. At this point, the light is right-handed circularized light 905. The light 905 is reflected a second time by the curved partially reflective reflector 703. The handedness is again reversed back to left-handed circularized light 904. The third-reflected light passes through the glass substrate 711, the QWP 712, the RP 713, and the LP 714 and is thereby shaped light 907 capable of being observed by or directed into a pupil of a human eye (not shown) as part of an image made by light 901 emitted from the display 702. The arrangement 900 can take many forms including an HMD or other form of headgear, a head mounted device, a head mounted screen, a wearable device, a VR headset, an AR or VR visor, a set of virtual reality glasses, or electronically enhanced eyewear. Alternatively, the arrangement can be part of a heads-up display (HUD). The display 702 can take one of several forms including an electronic image source, an electronic screen, an LED panel, an OLED panel, and an LCD panel.

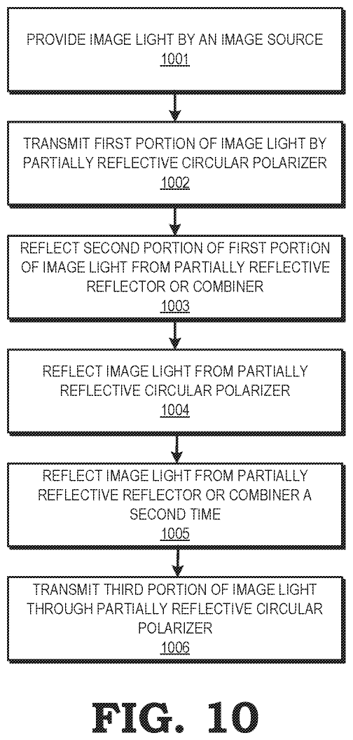

FIG. 10 is a flowchart illustrating a method of providing light to a user by way of a catadioptric device in accordance with certain illustrative embodiments. At 1001, image light is provided by an image source. At 1002, a first portion of the image light is transmitted through a partially reflective circular polarizing filter. The partially reflective circular polarizing filter may be a combination of elements. At 1003, a second portion of the first portion of image light is reflected from a partially reflective reflector or combiner such as reflector 703 of FIG. 7. At 1004, at least a portion of the second portion of light is reflected from the partially reflective circular polarizing filter or polarizer. At 1005, image light is reflected a second time by the partially reflective reflector or combiner. At 1006, a third portion of image light is transmitted through the partially reflective circular polarizer to reach a user eye. For example, such light is the linearly polarized light 315 of FIG. 3.

In some embodiments, certain aspects of the techniques described above may implemented by one or more processors of a processing system executing software such as to provide power to and control of elements in an electronic display for producing light to reach one or more user's eyes. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An optical device comprising:
a reflector;
a partially reflective circular polarizer, for selecting polarized light, positioned between the reflector and an expected position of a first user eye; and
an electronic display, configured to provide light to the first user eye, positioned at an eye-ward side of at least one of the reflector and the partially reflective circular polarizer.

2. The optical device of claim 1, wherein an optical axis of the reflector is offset from an optical axis of the polarizer.

3. The optical device of claim 1, wherein the reflector is partially reflective.

4. The optical device of claim 1, further comprising:
a frame shaped to rest against a portion of an anatomical structure of a user, the frame supporting the electronic display, the polarizer, and the reflector, the optical device implemented in a head mounted display (HMD).

5. The optical device of claim 1, wherein the reflector is curved along a first directional axis and is rotationally asymmetric along the first directional axis.

6. The optical device of claim 5, wherein the reflector is curved along a second directional axis and is rotationally asymmetric along the second directional axis.

7. The optical device of claim 1, wherein the partially reflective circular polarizer is curved along a first directional axis.

8. The optical device of claim 7, wherein the partially reflective circular polarizer is curved along a second directional axis different than the first directional axis.

9. The optical device of claim 1, wherein the partially reflective circular polarizer reflects orthogonal circular polarization after a first reflection of light energy from the reflector.

10. The optical device of claim 9, wherein the partially reflective circular polarizer transmits orthogonal circular polarization after a second reflection of light energy from the reflector.

11. The optical device of claim 1, wherein the electronic display is positioned on an eye-ward side of the partially reflective circular polarizer.

12. The optical device of claim 1, wherein the electronic display is positioned on a world-facing side of the partially reflective circular polarizer.

13. The optical device of claim 1, wherein the partially reflective circular polarizer comprises:
a quarter-wave plate (QWP);
a reflective polarizer layer; and
a linear polarizer.

14. The optical device of claim 13, wherein the partially reflective circular polarizer further comprises:
a supportive substrate made of at least one of a glass or a plastic; and
an anti-reflective film.

15. The optical device of claim 1, wherein the reflector comprises:
a mirror coating on an eye-ward surface of the reflector; or
anti-reflection coating on a world-facing surface of the reflector.

16. The optical device of claim 1, wherein the reflector and the partially reflective circular polarizer extend in front of the first user eye and a second user eye.

17. The optical device of claim 1, wherein the electronic display is a first electronic display positioned to provide light to the first user eye by reflection from the reflector, the optical device further comprising a second electronic display positioned to provide light to a second user eye by reflection from another reflector.

18. A head mounted display (HMD) apparatus comprising:
a reflector having a partial mirror coating on an eye-ward side of the reflector;
a partially reflective circular polarizer positioned between the reflector and a first user eye;
a display positioned at an eye-ward side of the reflector and configured to provide light to the first user eye; and
a polarization filter at an output of the partially reflective circular polarizer.

19. The HMD apparatus of claim 18, wherein the polarization filter is laminated directly on the display, and wherein the polarization filter comprises a linear polarizer and a quarter-wave retarder film.

20. A method for viewing imagery with a head mounted display (HMD), the method comprising:
providing image light by an image source;
reflecting a first portion of the image light by a partially reflective circular polarizer;
reflecting a second portion of the first portion of the image light from a reflector, the reflector being at least partially reflective; and
transmitting a third portion the image light, the third portion linearly polarized by passing through the partially reflective circular polarizer to a user eye.

21. The method of claim 20, further comprising:
combining the third portion of the image light with ambient light passing through the reflector and the partially reflective circular polarizer from a world side of the reflector to provide a combined image to the user eye at an eye-ward side of the partially reflective circular polarizer, the image light overlaid on a view of an external ambient provided by the ambient light.

22. The method of claim 20, wherein the first portion of the image light is light that has been subjected to a linear polarizer and a quarter-wave retarder film prior to being reflected by the partially reflective circular polarizer.

23. The method of claim 20, wherein the first portion of the image light is light that has been subjected to a linear polarizer, a circular polarizer, and a quarter-wave retarder film prior to being reflected by the partially reflective circular polarizer.
